(19) United States
(12) Patent Application Publication
(10) Pub. No.: US 2003/0236043 A1
(43) Pub. Date: Dec. 25, 2003

(54) Glass fiber duct liner

(76) Inventors: Thomas S. Calzavara, Littleton, CO (US); Kent Russell Matthews, Littleton, CO (US); Eric G. Schakel, Sedalia, CO (US)

Correspondence Address: Robert D. Touslee, Johns Manville Corporation, 10100 West Ute Avenue, Littleton, CO, 80127, US

(21) Appl. No.: 10/178,163

(22) Filed: Jun. 24, 2002

(51) Int. Cl. B32B 27/04; F16L 9/14; D04H 1/00

(52) U.S. Cl. 442/79; 442/93; 442/123; 442/172; 442/180; 138/140; 138/149

(57) ABSTRACT

A glass fiber duct liner, for lining sheet metal ducts in air conditioning, heating and ventilating systems, includes a flexible blanket of biosoluble glass fibers exhibiting a biodisolution rate in excess of 150 ng/cm²/hr. The glass fibers of the blanket are bonded together at their points of intersection by a colorless, formaldehyde-free, thermosetting, acrylic acid-based latex binder resin. A major surface of the blanket, adapted to be an interior surface of the blanket over which an airstream is to be conveyed by a duct system, is coated with a white acrylic latex water and dirt repellant coating that contains an antimicrobial agent.

### BACKGROUND OF THE INVENTION

The subject invention relates to a flexible duct liner insulation specifically designed for lining sheet metal ducts in air conditioning, heating and ventilating systems. More particularly, the subject invention relates to a flexible duct liner insulation of biosoluble glass fibers bonded together with a formaldehyde-free acrylic binder resin wherein the binder resin cures without coloration of the duct liner insulation and an interior airstream surface of the duct liner insulation is coated with a white acrylic latex water and dirt repellant coating containing an antimicrobial agent.

Sheet metal ducts of air conditioning, heating and ventilating systems are normally lined with flexible glass fiber duct liner insulations that are coated on the interior with acrylic latex coatings. These duct liner insulations control both sound and thermal transmissions within and through the air conditioning, heating and ventilating systems to reduce transmitted noise and conserve energy. The preparation and/or subsequent processing of these duct liner insulations often involves handling steps, e.g. cutting, that result in cut or broken fibers which may be inhaled. Accordingly, the formation of the glass fibers in these duct liner insulations from glass compositions that exhibit high degrees of biosolubility, i.e. glass compositions that are rapidly solubilized in biological fluids, is desirable. However, in addition to being biosoluble such glass fibers should be: strong to minimize glass fiber breakage so that the insulation duct liners made with the glass fibers recover substantially to their pre-compressed thickness after compression packaging; moisture resistant so that the glass fibers do not appreciably weaken when the insulation duct liners are stored in humid conditions; and made from glass compositions that are easy and economical to process.

The glass fibers within and forming these duct liner insulations are normally bonded together at their points of intersection by phenol/formaldehyde binding resins. While these binding resins are economical and can be extended with urea prior to use as a binder, the industry's desire to minimize volatile organic compound emissions (VOCs) to provide a cleaner environment and the presence of increasingly stringent federal regulations makes the use of binders with reduced VOCs in these duct liner insulations desirable. In addition, when these phenol/formaldehyde binder resins are cured they impart a color to the insulation blanket cores of the duct liner insulations, e.g. a yellow color that is not aesthetically pleasing. Thus, there has been a need to utilize binders in these insulation blanket cores: that reduce or eliminate unwanted VOCs, that can be easily applied to the glass fibers forming the insulation blanket cores, that are cost effective, and that do not color the insulation blanket cores.

### SUMMARY OF THE INVENTION

The glass fiber duct liner insulation of the subject invention, for lining sheet metal ducts in air conditioning, heating and ventilating systems, includes a flexible blanket of biosoluble glass fibers exhibiting a biodisolution rate in excess of 150 ng/cm²/hr. The glass fibers of the blanket forming the core of the duct liner insulation of the subject invention are bonded together at their points of intersection by a formaldehyde-free, thermosetting, acrylic acid-based latex binder resin that cures without coloration of the blanket. A major surface of the blanket, adapted to be an interior surface of the duct liner insulation over which an airstream is to be conveyed by a duct system, is coated with a white, acrylic latex, water and dirt repellant, erosion resistant, coating that contains an antimicrobial agent.

### BRIEF DESCRIPTION OF THE DRAWINGS

FIG. 1 is a partial perspective view of the duct liner insulation of the subject invention installed in a sheet metal duct of an air conditioning, heating and ventilating system.

FIG. 2 is an enlarged detail of the encircled portion of FIG. 1.

### DESCRIPTION OF THE PREFERRED EMBODIMENT

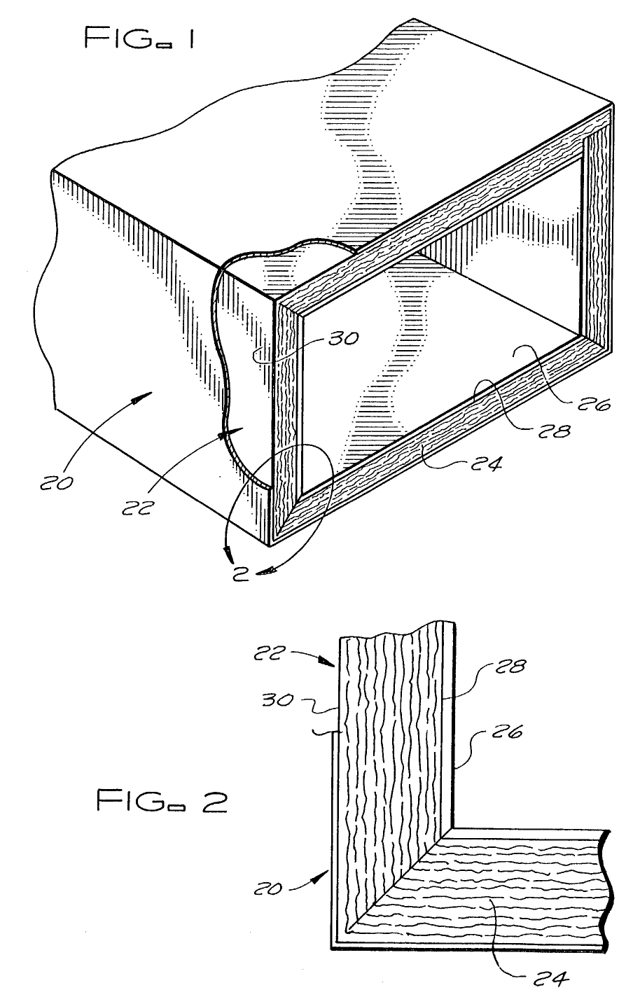

FIG. 1 shows a sheet metal duct 20 lined with the flexible duct liner insulation 22 of the subject invention. The duct liner insulation 22 includes a glass fiber insulation blanket core 24 and a coating 26 on and coextensive with an inner major surface 28 of the glass fiber blanket core. Typically, the duct liner insulation 22 is secured to an interior surface of the sheet metal duct 20 by adhesively bonding an outer major surface 30 of the blanket core 24 to the interior surface of the sheet metal duct and by passing conventional mechanical fastener pins (not shown) through the duct liner insulation 22 and into the sheet metal duct.

The glass fiber blanket core 24 is flexible and typically has a density between about 1 (0.37 Kg/m³) and about 4 pound/ft³ (1.5 Kg/m³). The glass fiber blanket core 24 is between ½ of an inch (13 mm) and 2 inches (51 mm) in thickness; between 34 inches (864 mm) and 60 inches ( 1524 mm) in width; and about 50 feet (15 lineal meters) to 200 feet (61 lineal meters) in length. The glass fibers of the glass fiber blanket core 24 are made from a glass composition that exhibits a biodisolution rate in excess of 150 ng/cm²/hr. While other suitable glass compositions may be used to form glass fibers of the duct liner insulation 22 with the required physical properties, preferred glass compositions used to form the glass fibers of the duct liner insulation 22 are disclosed in U.S. Pat. No. 5,945,360, issued Aug. 31, 1999 (hereinafter referred to as the “'360 patent”) and the disclosure of that patent is hereby incorporated herein in its entirety by reference. The preferred glass compositions of the '360 patent may be used in pot and marble, flame attenuation glass fiberization processes.

The preferred glass compositions of the '360 patent have high temperature viscosity (HTV) and liquidus which are suitable for production of glass fibers in the pot and marble process. Such glass compositions generally must have an HTV (10³ poise) of 1800° F. to 2100° F., preferably 1900° F. to 2000° F., exhibit a liquidus which is minimally about 350° F., preferably 425° F., and preferably, 500° F. or lower than the HTV. These characteristics are necessary to prepare glass fibers economically on a continuous basis. The preferred glass composition must fall within the following range of compositions, in mol percent:

| | |
|---|---|
| SiO₂ | 66-69.7 |
| Al₂O₃ | 0-2.2 |
| RO | 7-18 |
| R₂O | 9-20 |
| B₂O₃ | 0-7.1 |

where R₂O is an alkali metal oxide and RO is an alkaline earth metal oxide. R₂O is preferably Na₂O in most substantial part, while RO may be MgO and/or CaO, preferably both, in a molar ratio of MgO/CaO of 1:3 to 3:1, more preferably 2:3 to 3:2. The chemical behavior of the glass is dictated by three ratios which the glass composition must meet, C(acid), C(bio), and C(moist). These ratios are defined compositionally as follows, all amounts being in mol percent:

C(acid)=[SiO₂]/([Al₂O₃]+B₂O₃]+[R₂O]+[RO])

C(bio)=([SiO₂]+[Al₂O₃])/([B₂O₃]+[R₂O]+[RO])

C(moist)=([SiO₂]+[Al₂O₃]+(B₂0₃])/([R₂O]+[RO]).

In these ratios, C(acid) is the ratio which pertains to chemical resistance in acid environments, C(bio) is the ratio which is most closely linked to biosolubility, and C(moist) is the ratio which relates to the retention of properties in moist environments. It is desired that C(acid) and C(moist) be as large as possible, while C(bio) should be as low as possible. At the same time, the HTV (10³ poise) and liquidus of the overall composition must be suitable for glass fiber processing in the pot and marble flame attenuation process [a difference, ΔT, between HTV (10³ poise) and liquidus in excess of 350° F.]. It has been found that pot and marble glass of high biosolubility made by flame attenuated processes maintain other necessary physical properties, while yet maintaining other necessary physical properties such as chemical resistance and moisture resistance, is obtained when C(acid)≧1.95, C(bio)≦2.30, and C(moist)≧2.40.

Preferably, the biosoluble glass fibers used in the glass fiber blanket core 24 have a composition which falls within the following ranges (in mol percent):

| | |
|---|---|
| SiO₂ | 66-69.0 |
| Al₂O₃ | 0-2.2 |
| RO | 7-16 |
| R₂O | 9-19 |
| B₂O₃ | 0-7.1 |

Most preferably, the biosoluble glass fibers used in the glass fiber blanket core have a composition which falls within the following ranges (in mol percent):

| | |
|---|---|
| SiO₂ | 66-68.25 |
| Al₂O₃ | 0-2.2 |
| RO | 7-13 |
| R₂O | 11-18 |
| B₂O₃ | 0-7.1 |

With respect to the performance characteristics of the glass fibers used in the glass fiber blanket core 24, it is preferred that C(acid) be greater than or equal to 2.00; C(bio) be less than or equal to 2.23, more preferably, less than or equal to 2.20; and that C(moist) be greater than or equal to 2.46, more preferably greater than or equal to 2.50, most preferably greater than or equal to 2.60. As discussed previously, it is most desirable that C(acid) and C(moist) values be as high as possible. For example, C(moist) values of 3.00 or greater are particularly preferred. It should also be noted that the various C-ratios are independent in the sense that a more preferred glass need not have all “more preferred” C-ratios.

The acid resistance of the fibers may be measured by battery industry standard tests. For example, a typical test involves the addition of 5 grams of nominally 3 micron diameter fiber in 50 mL of sulfuric acid having a specific gravity of 1.26. Following refluxing for 3 hours, the acid phase may be separated by filtration and analyzed for dissolved metals or other elements.

The procedure used to evaluate biodissolution rate of the fibers is similar to that described in Law et al. (1990). The procedure consists essentially of leaching a 0.5 gram aliquant of the candidate fibers in a synthetic physiological fluid, known as Gamble's fluid, or synthetic extracellular fluid (SEF) at a temperature of 37° C. and rate adjusted to achieve a ratio of flow rate to fiber surface area of 0.02 cm/hr to 0.04 cm/hr for a period of up to 1,000 hours duration. Fibers are held in a thin layer between 0.2 micron polycarbonate filter media backed by plastic support mesh and the entire assembly placed within a polycarbonate sample cell through which the fluid may be percolated. Fluid pH is regulated to 7.4+0.1 through the use of positive pressure of 5% CO₂/95% N₂ throughout the flow system.

Elemental analysis using inductively coupled plasma spectroscopy (ICP) of fluid samples taken at specific time intervals are used to calculate the total mass of glass dissolved. From this data, an overall rate constant can be calculated for each fiber type from the relation:

k={d₀ p(1−(M/M₀)^{0 5})/2t

where: k is the dissolution rate constant in SEF, d₀ the initial fiber diameter, p the initial density of the glass comprising the fiber, M₀ the initial mass of the fibers, M the final mass of the fibers (M/M₀=the mass fraction remaining), and t the time over which the data was taken. Details of the derivation of this relation are given in Leinweber (1982) and Potter and Mattson (1991). Values for k may be reported in ng/cm²/hr and preferably exceed a value of 150. Replicate runs on several fibers in a given sample set show that k values are consistent to within 3 percent for a given composition.

Data obtained from the above outlined evaluation can be effectively correlated within the sample set chosen. While the mean fiber diameter of the fibers used in the lightweight insulation products of the present invention is about 1+/−0.25 microns, dissolution data used to derive k values for the glass fibers used in the lightweight glass fiber insulations of the present invention were obtained only from experimental samples of uniform 3.0 micron diameter and under identical conditions on initial sample surface area per volume of fluid per unit time, and sample permeability. Data was obtained from runs of up to 30 days to obtain an accurate representation of the long term dissolution of the fibers. Preferred biodissolution rate constants in ng/cm²/hr are greater than 150 ng/cm²/hr, preferably greater than 200 ng/cm²/hr, more preferably greater than 300 ng/cm²/hr, and most preferably greater than 400 ng/cm²/hr.

To the determine moisture resistance of the glass fibers, a stress corrosion test is used in which fibers are stressed by bending the fibers in a controlled humidity and temperature test chamber. Fibers which exhibit moisture resistance under these conditions take longer to break.

With respect to the preferred glass compositions used to form the glass fibers in the insulation blanket core 24, by the term “consisting essentially of” is meant that additional ingredients may be added to the composition provided the additional ingredients do not substantially alter the nature of the composition. Substances which cause the biodissolution rate to drop below 150 ng/cm²/hr or which lower the ΔT to a value below 350° F. are substances which do substantially alter the composition. Preferably, the glass compositions are free of iron oxides, lead oxides, fluorine, phosphates (P₂O₅), zirconia, and other expensive oxides, except as unavoidable impurities.

The primary fibers exiting from the pot in the pot and marble fiberization process are flame attenuated rather than hot gas attenuated, thus exposing the glass fibers to higher temperatures than in a rotary fiberization process. These higher temperatures cause a loss of the more volatile compounds of the glass composition from the outside of the fibers, resulting in a “shell” which has a different composition than the fiber interior. As a result, the biosolubility of glass fibers prepared from the pot and marble fiberization process is not the same as that derived from a rotary fiberization process. It should be noted that while rotary process glass compositions are in general unsuitable for pot and marble fiberization process, the reverse is not true, the preferred glass compositions of the subject invention should yield fibers prepared by the rotary process which have yet higher rates of biodissolution.

The formaldehyde-free, thermosetting, acrylic acid-based latex binder resins used in the insulation blanket core 24 can be applied with minimal processing difficulties and enable the core 24 to have good recovery. The preferred formaldehyde-free, thermosetting, acrylic acid-based binder resins cure without any coloration of the blanket by crosslinking with a poly-functional, carboxyl group-reactive curing agent. One such preferred acrylic acid-based latex binder resin is a binder that includes a polycarboxy polymer and glycerol. It is also preferred that the binder comprises a catalyst, such as an alkaline metal salt of a phosphorous-containing organic acid, most preferably sodium hypophosphite. An important aspect of the binder is that the polycarboxy polymer used in the binder in combination with the glycerol has a very low molecular weight. It is preferred that the molecular weight of the polycarboxy polymer is less than 10,000, more preferably 5000 or less, and most preferably around 3000 or less with around 2000 molecular weight giving excellent results.

The use of glycerol in combination with the low molecular weight polycarboxy polymer, preferably polyacrylic acid, has been found to avoid any formaldehyde emissions and provide a binder which cures colorless. The use of such a low molecular weight polycarboxy polymer in the binder also beneficially results in a binder which exhibits few, if any, processing difficulties when preparing the insulation blanket core 24.

The polycarboxy polymer used in the binder comprises an organic polymer or oligomer containing more than one pendant carboxy group. The polycarboxy polymer may be a homopolymer or copolymer prepared from unsaturated carboxylic acids including but not necessarily limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Alternatively, the polycarboxy polymer may be prepared from unsaturated anhydrides including, but not necessarily limited to, maleic anhydride, methacrylic anhydride, and the like, as well as mixtures thereof. Methods for polymerizing these acids and anhydrides are well-known in the chemical art.

The polycarboxy polymer of the binder may additionally comprise a copolymer of one or more of the aforementioned unsaturated carboxylic acids or anhydrides and one or more vinyl compounds including, but not necessarily limited to, styrene, α-methylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, vinyl methyl ether, vinyl acetate, and the like. Methods for preparing these copolymers are well-known in the chemical art.

Preferred polycarboxy polymers for the binder comprise homopolymers and copolymers of acrylic acid.

An important aspect of the binder relates to the molecular weight of the polycarboxy polymer used in the formaldehyde-free curable aqueous binder composition. The molecular weight of the polycarboxy polymer is less than 10,000 and more preferably less than 5000. Most preferably, the molecular weight of the polycarboxy acid is about 3000, and can be even less, as a molecular weight of about 2000, e.g. 2100, is most advantageous. It has been found that when such a low molecular weight polycarboxy acid is used in the binder resin, the binder resin can be successfully employed in the processing of a glass fiber product with little difficulty with regard to sticking or balling of the glass fibers. As a result, a much more efficient process is realized and a more economical product can be obtained by the use of the binder.

The formaldehyde-free curable binder composition also contains specifically glycerol. The use of glycerol with a polycarboxy polymer such as a polyacrylic acid results in a colorless binder upon curing. This enables the insulation blanket core 24 to be white. Other crosslinking polyols, such as triethanolamine, result in a binder which is light brown, thereby coloring the final product and being unsuitable where white is the desired product color.

The ratio of the number of equivalents of carboxy, anhydride, or salts thereof of the polyacid to the number of equivalents of hydroxyl groups from the glycerol is from about 1/0.01 to about ⅓. An excess of equivalents of carboxy, anhydride, or salts thereof of the polyacid to the equivalents of hydroxyl groups from the glycerol is preferred. The more preferred ratio of the number of equivalents of carboxy, anhydride, or salts thereof in the polyacid to the number of equivalents of hydroxyl in the glycerol is from about 1/0.2 to about 1/1. The most preferred ratio of the number of equivalents of carboxy, anhydride, or salts thereof in the polyacid to the number of equivalents of hydroxyl in the glycerol is from about 1/0.4 to about 1/0.95 with a ratio of from about 1/0.6 to about 1/0.8 being even more preferred, and a ratio of from about 1/0.65 to about 1/0.75 being most preferred.

The formaldehyde-free curable aqueous binder composition also preferably contains a catalyst. Most preferably, the catalyst is a phosphorous-containing accelerator which may be a compound with a molecular weight less than about 1000 such as, for example, an alkali metal polyphosphate, an alkali metal dihydrogen phosphate, a polyphosphoric acid, and an alkyl phosphinic acid or it may be an oligomer or polymer bearing phosphorous-containing groups such as, for example, addition polymers of acrylic and/or maleic acids formed in the presence of sodium hypophosphite, addition polymers prepared from ethylenically unsaturated monomers in the presence of phosphorous salt chain transfer agents or terminators, and addition polymers containing acid-functional monomer residues such as, for example, copolymerized phosphoethyl methacrylate, and like phosphonic acid esters, and copolymerized vinyl sulfonic acid monomers, and their salts. The phosphorous-containing accelerator may be used at a level of from about 1% to about 40% by weight based on the combined weight of the polyacid and the polyol. Preferred is a level of phosphorous-containing accelerator of from about 2.5% to about 10% by weight based on the combined weight of the polyacid and the polyol. The most preferred catalyst for the binder resin is sodium hypophosphite.

The formaldehyde-free curable aqueous binder composition may contain, in addition, conventional treatment components such as, for example, emulsifiers, pigments, filler, anti-migration aids, curing agents, coalescents, wetting agents, biocides or antimicrobial agents, plasticizers, organosilanes, anti-foaming agents, waxes, and anti-oxidants.

The formaldehyde-free curable aqueous binder composition may be prepared by admixing the polyacid, the glycerol, and the phosphorous-containing accelerator using conventional mixing techniques. The carboxyl groups of the polyacid may be neutralized to an extent of less than about 35% with a fixed base before, during, or after the mixing to provide the aqueous composition. Neutralization may be partially effected during the formation of the polyacid.

The formaldehyde-free curable aqueous composition may be applied to the insulation blanket core 24 by conventional techniques, for example, by spraying the composition into the curtain of fibers as the fibers are directed toward the collection conveyor to form the insulation blanket core 24. The insulation blanket core 24 is then passed through a curing oven where heated air is passed through the blanket to cure the resin. The blanket is slightly compressed to give the blanket a selected thickness and surface finish. Typically, the curing oven is operated at a temperature from about 150° C. to about 325° C. and, preferably, from about 180° C. to about 250° C. The cure time in the oven ranges from about ½ minute to about 3 minutes and, typically from about 1 minute to about 2½ minutes.

The formaldehyde-free, thermosetting, acrylic acid-based latex binder resin, bonding the fibers of the insulation blanket core together, cures without coloration of the insulation blanket core 24. The major surface 28 of the insulation blanket core 24 that forms the inner or airstream surface of the duct liner insulation 20 and, preferably, both the major surface 28 of the insulation blanket core 24 and the lateral and end edges of the insulation blanket core 24 are coated with a white acrylic water and dirt repelling coating 26 that contains an antimicrobial agent. Accordingly, the preferred glass fiber duct liner insulation 20 appears white.

Typical coating compositions used in the coating 26 comprise aqueous acrylic emulsions with catalysts to initiate cross-linking of the compositions in response to the application of heat such as but not limited to an aqueous acrylic emulsion with catalysts to initiate cross-linking in response to the application of heat sold by Tanner Chemical under the trade designation 9985 White FP. These coating compositions can be formulated to vary their elasticity, abrasion resistance, rigidity, density, flammability, water resistance, color, etc. These coating compositions may also include ingredients, such as but not limited to pigments, inert fillers, fire retardant particulate additives, antimicrobial agents, organic or inorganic biocides, bactericides, fungicides, rheology modifiers, water repellents, surfactants and curing catalysts. In the preferred embodiment of the subject invention, the coating is white and includes a white pigment such as but not limited to titanium dioxide and an antimicorbial agent.

A typical froth coating used to coat the glass fiber insulation blanket core 24 includes:

| | Weight Percent |
|---|---|
| Aqueous Acrylic Latex Emulsion | 20-90 |
| (Not Pressure Sensitive) | |
| Curing Catalyst | 0.1-1.0 |
| Froth Aids | 1-10 |
| Foam Stabilizer | 1-5 |
| Mineral Filler, including | 0-60 |
| Flame Retardants | |
| Color Pigments | 1-6 |
| Rheology Control Thickener | 1-6 |
| Antimicrobial agent | 0.1-0.3 |

Final solids content is from about 20 to about 85 weight percent. The application viscosity is about 500 to about 15,000 centipoise. Froth density is measured as a “cup weight”, i.e. the weight of frothed coating composition in a 16 ounce paper cup, level full. A cup weight of about 55 to about 255 grams is typical.

The coating 26 may be a single layer coating or a multilayered coating. When the coating 26 is a multilayered coating, each discrete layer of the coating can be specifically formulated to better perform a specific function. For example, a first discrete layer of the coating can be formulated to be more elastic than the second discrete layer to make the coating more puncture resistant while the second layer, if it is the exposed layer, can be formulated to be more abrasion resistant than the first coating layer. Thus, with the multilayered coating, there is the opportunity to make the coating 26 more tear and puncture resistant to minimize damage to the coating during the packaging, shipment, handling and installation of the insulation sheets.

Other examples of discrete coating layers which can be specifically formulated and used in the coating 26, to provide or enhance specific performance characteristics or reduce the cost of the coating 26, include but are not limited to, layers formulated with biocides, layers that can fulfill a specific performance characteristic that can made of less expensive coating formulations due to their location in the multilayered coating, layers with improved water resistance, and layers with reduced flammability or smoke potential.

In addition, to providing the opportunity to form different coating layers of the coating 26 from coating compositions having different formulations, the individual layers of the coating 26 can be made of different weights or thicknesses to enhance a specific performance characteristic or reduce coating costs without sacrificing performance, e.g. a discrete substrate layer can be thicker than the surface layer. The coating 26 typically ranges in dry weight from about 6 to about 20 grams per square foot. Thus, by way of example, one discrete coating layer of the coating 26 could have a dry weight of about 10 grams/sq. ft. and another discrete coating layer of the coating 26 could have a dry weight of about 4 grams/sq. ft.

The coating 26 may be applied by conventional coating techniques such as those disclosed in U.S. Pat. No. 4,990,370, issued Feb. 5, 1991, or U.S. Pat. No. 5,211,988, issued May 18, 1993, or U.S. Pat. No. 6,284,313, issued Sep. 4, 2001. The disclosures of U.S. Pat. Nos. 4,990,370; 5,211,988; and 6,284,313 are hereby incorporated herein by reference in their entirety.

In describing the invention, certain embodiments have been used to illustrate the invention and the practices thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

What is claimed is:

1. A glass fiber duct liner for lining sheet metal ducts in air conditioning, heating and ventilating systems, comprising:
a flexible blanket of glass fibers; the blanket having first and second major surfaces defined by lateral edges and end edges; the first major surface of the blanket being adapted to be an interior surface of the blanket over which an airstream is to be conveyed by a duct system; the second major surface of the blanket being adapted to be an outer surface of the blanket that is secured to an interior surface of a duct in a duct system to line the duct system; the flexible blanket being formed of biosoluble glass fibers exhibiting a biodisolution rate in excess of 150 ng/cm²/hr; the glass fibers of the blanket being bonded together at their points of intersection by a formaldehyde-free, thermosetting, acrylic acid-based latex binder resin which cures without any coloration of the blanket; and
the first major surface of the blanket being coated with a white acrylic latex coating that is water and dirt repelling and contains an antimicrobial agent.

2. The glass fiber duct liner according to claim 1, wherein:
the acrylic acid-based latex binder resin comprises a polycarboxy polymer of a molecular weight of less than 10,000, and a glycerol.

3. The glass fiber duct liner according to claim 2, wherein:
the polycarboxy polymer comprises homopolymers and copolymers of polyacrylic acid.

4. The glass fiber duct liner according to claim 3, wherein:
the glass fibers are prepared by pot and marble fiberization and have a shell exterior, which has a different composition than the fiber interior; and the glass fibers are prepared from a glass composition consisting essentially of, in mol percent:

| | |
|---|---|
| SiO₂ | 66-69.7 |
| Al₂O₃ | 0-2.2 |
| RO | 7-18 |
| R₂O | 9-20 |
| B₂O₃ | 0-7.1 |

the glass composition having a C(acid)≧1.95, C(bio)≦2.30, and C(moist)≧2.40, a difference, ΔT, between HTV (10³ poise) and liquidus in excess of 350° F.

5. The glass fiber duct liner according to claim 1, wherein:
the glass fibers are prepared by pot and marble fiberization and have a shell exterior, which has a different composition than the fiber interior; and the glass fibers are prepared from a glass composition consisting essentially of, in mol percent:

| | |
|---|---|
| SiO₂ | 66-69.7 |
| Al₂O₃ | 0-2.2 |
| RO | 7-18 |
| R₂O | 9-20 |
| B₂O₃ | 0-7.1 |

the glass composition having a C(acid)≧1.95, C(bio)≦2.30, and C(moist)≧2.40, a difference, ΔT, between HTV (10³ poise) and liquidus in excess of 350° F.
